(19) United States
(12) Patent Application Publication
(10) Pub. No.: US 2007/0013805 A1
(43) Pub. Date: Jan. 18, 2007

(54) Method and apparatus for protecting mechanical lens of cameras using miniature hard drive as gyro sensor

(75) Inventor: Mike Suk, San Jose, CA (US)

Correspondence Address: INTELLECTUAL PROPERTY LAW OFFICES, 1901 SOUTH BASCOM AVENUE, SUITE 660, CAMPBELL, CA, 95008, US

(73) Assignee: Hitachi Global Storage Technologies Netherlands B.V.

(21) Appl. No.: 11/182,559

(22) Filed: Jul. 15, 2005

(51) Int. Cl. H04N 5/232; G03B 13/00

(52) U.S. Cl. 348/347

(57) ABSTRACT

A digital camera is presented having protection from impact by falling, including a miniature hard drive having an actuator assembly, and a zoom lens and a zoom lens retractor mechanism. The miniature hard drive includes a detector that senses when the digital camera is falling by either reading a motor current signal, or a disk rotational velocity signal, and interrupt signal generator produces an interrupt signal if a falling condition is sensed. A retractor mechanism for the zoom lens responds to the interrupt signal to retract the zoom lens. A method for preventing damage to a zoom lens and miniature hard drive in a digital camera are also presented.

### BACKGROUND OF THE INVENTION

1. Field of the Invention

This invention relates generally to protection systems for miniature hard drives in digital cameras, and more particularly, to a reflexive system for retracting a zoom lens in a digital camera if it is dropped.

2. Description of the Prior Art

Digital cameras have been growing in popularity as more users learn to download the digital images from the camera to their personal computer and printers. The resolution of digital cameras has been steadily increasing so that the number of pixels per square inch increases along with the size of the digital image files they generate. As of this writing, cameras produce images of 8 megapixels and up, which means that the storage capacity must increase as well if an adequate number of pictures is to be stored between downloads. Memory chips of increasing capacity have been introduced, but these of course have size limitations. Some digital cameras are also equipped to produce short captures of action sequences or movies, and the storage demands for these kinds of cameras are greater still.

In answer to these storage limitations, small miniature disk drives are being more frequently used. The storage capacity of these miniature hard drives can greatly exceed that of memory chips, and the physical dimensions of a miniature hard drive have become so small that they can be easily incorporated into digital cameras without making the cameras unnecessarily bulky.

Miniature hard drives however have vulnerabilities that memory chips do not, as the hard disk drive has the lower threshold of failure in the event that the camera, and included miniature hard drive, is dropped.

A typical hard disk drive, such as a miniature hard drive, includes at least one rotatable magnetic disk which is supported on a spindle and rotated by a disk drive motor. The magnetic recording media on each disk is in the form of an annular pattern of concentric data tracks on the disk. At least one slider is positioned on the disk, each slider supporting one or more magnetic read/write heads. As the disks rotate, the slider is moved radially in and out over disk surface so that heads may access different portions of the disk where desired data is recorded. Each slider is attached to a positioner arm by a suspension. The suspension provides a slight spring force which biases the slider against the disk surface.

During operation of the disk drive system, the rotation of the disk generates an air bearing between the slider and the disk surface which exerts an upward force or lift on the slider. The air bearing thus counter-balances the slight spring force of the suspension and supports the slider off and slightly above the disk surface by a small, substantially constant spacing during normal operation. The head on the slider is literally flown over the disk surface to place the head as close to the disk surface as possible without allowing contact.

The hard disk drive is so vulnerable to shock because it is dependent on the maintenance of this very small gap between the drive heads and the surface of the hard disks. If the head were to contact the disk, the result could be both the destruction of the head and the removal of magnetic material (and hence data) from the disk surface.

U.S. Pat. No. 6,101,062 to one of the current inventors describes a method and apparatus for detecting harmful motion of a disk drive system to avoid a head crash. The motor spin current in the hard disk drive is used as a sensor to detect acceleration of the disk drive corresponding to a tipping or falling condition. In normal operation, the disk stack angular velocity (measured in revolutions per minute or RPM) is constantly monitored so that the disk drive control system can generate timing signals allowing the controller to accurately locate data addresses on the rotating disks. Disk stack RPM is accurately controlled at a constant value by a suitable feedback control loop which measures RPM and adjusts motor drive current to maintain the desired RPM. The rapidly rotating disk stack acts as a gyro system whose angular momentum resists any change in direction. In the event of a change in orientation of the disk drive such as that initiated by tipping or falling, gyroscopic forces are generated which act to increase friction of the bearings supporting the rotating disk stack resulting in a decrease in disk stack angular velocity. The change of disk stack RPM is detected by the normal feedback control loop electronics and an error signal can be generated to cause actuator park or unload action before impact of the falling disk drive occurs.

In addition to the vulnerability of the hard disk in the digital camera, other elements of the camera may be especially vulnerable to damage by dropping. In particular, most digital cameras extend and retract the lens as the user adjusts the optical zoom feature. While the lens is extended, the mechanical system and the lens could be severely damaged if dropped on the ground. To alleviate this potential problem, the lens system should be retracted when the camera is dropped, but before it hits the ground. This can be done with an integrated accelerometer; however, this type of sensor usually detects contact, which may be too late.

Therefore, there is a need for a shock protection device for a digital camera with a miniature hard disk drive that prevents damage to the lens extension system as well as the heads and disk surfaces of the miniature hard drive in the event of a fall.

### SUMMARY OF THE INVENTION

A preferred embodiment of the present invention is a digital camera and method of preventing damage to a zoom lens system and miniature hard drive in a digital camera having a zoom lens, and a zoom lens retractor mechanism.

The miniature hard drive includes a detector that senses when the digital camera is falling. The detector includes a device for reading a motor current signal, and a device for generating a first and second exponential average of a motor current signal having different decay time constants. Also included are a comparator for comparing the difference between the first and second exponential averages with a threshold value stored in memory; and interrupt signal generator for producing an interrupt signal if the exponential average difference exceeds the threshold value. An activator for the zoom lens retractor mechanism responds to the interrupt signal.

Alternately, the detector includes a device for reading a disk rotational velocity signal, and a device for generating a first and second exponential average of the disk rotational velocity signal having different decay time constants. Also included are a comparator for comparing the difference between the first and second exponential averages with a threshold value stored in memory, and an interrupt signal generator for producing an interrupt signal if the exponential average difference exceeds the threshold value. An activator for the zoom lens retractor mechanism responds to the interrupt signal.

The method includes providing a miniature hard drive internal to the digital camera capable of detecting that the digital camera is falling. When the condition has been detected that said digital camera is falling, an interrupt signal is generated and an interrupt signal is sent to the zoom lens retractor mechanism to retract the zoom lens. The miniature hard drive can detect the condition by reading a motor current signal, generating a first and second exponential average of the motor current signal, having different decay time constants and comparing the difference between the first and second exponential averages with a threshold value. Alternately, the miniature hard drive can detect the condition by reading a disk rotational velocity signal, generating a first and second exponential average of the disk rotational velocity signal having different decay time constants and comparing the difference between the first and second exponential averages with a threshold value.

It is an advantage of the present invention that it provides a protective reflex system for a digital camera with miniature hard disk drive which protects the zoom lens system of the camera from impact damage.

It is another advantage of the present invention that it provides a shock prevention device and protective reflex system for the miniature disk drive in a digital camera which initiates protective action before the miniature hard disk suffers shock from an impact.

It is a further advantage of the present invention that it provides, in a digital camera with included miniature hard disk drive, a method by which zoom lens components may be retracted and thus protected from impact in the event of a fall, which causes minimal increase to the cost and/or complexity of the digital camera.

It is a yet further advantage of the present invention that it provides, in a digital camera with included miniature hard disk drive, a method by which heads in the normal active state may be protected from impact with the disk surfaces in the event of a fall, which causes minimal increase to the cost and/or complexity of the hard disk drive.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a perspective view of a digital camera having a miniature hard disk drive; and a zoom lens system;

FIG. 2 is a simplified cut away view of a digital camera having a miniature hard disk drive and a zoom lens system with retracting mechanism;

FIG. 3 is a simplified block diagram of a magnetic recording disk drive system;

FIG. 4 is a perspective view of a disk drive;

FIG. 5 is a block diagram illustrating a typical disk drive servo control system;

FIG. 6 is a simplified cut away view of a disk stack in a hard disk drive;

FIG. 7 is a flow chart illustrating the preferred embodiment of the unload/retract servo control loop of the miniature hard drive wherein exponential averaging of the motor DAC is used; and

FIG. 8 is a flow chart illustrating the preferred embodiment of the unload/retract servo control loop of the present invention wherein motion signature time stamps are used.

### DETAILED DESCRIPTION OF THE PREFERRED EMBODIMENTS

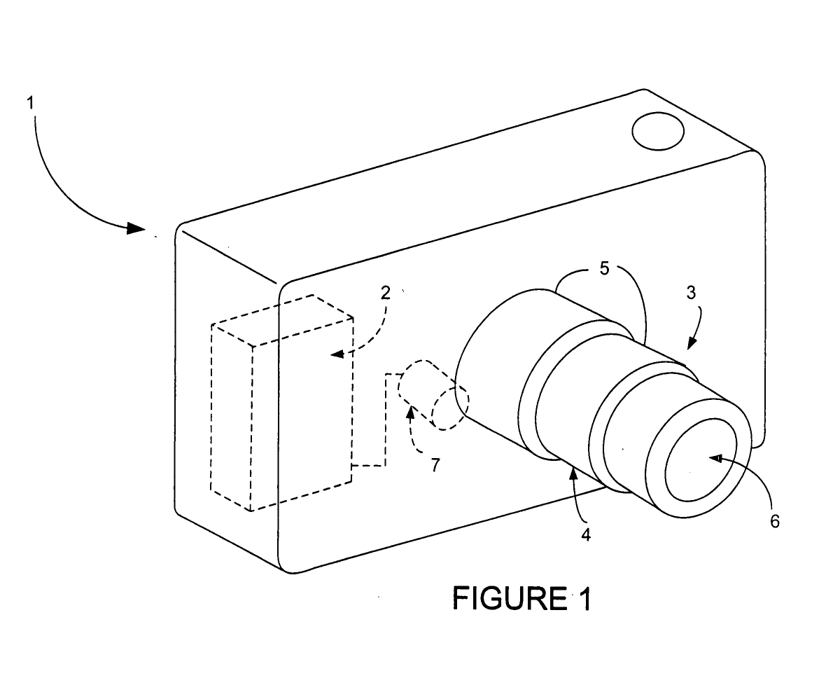

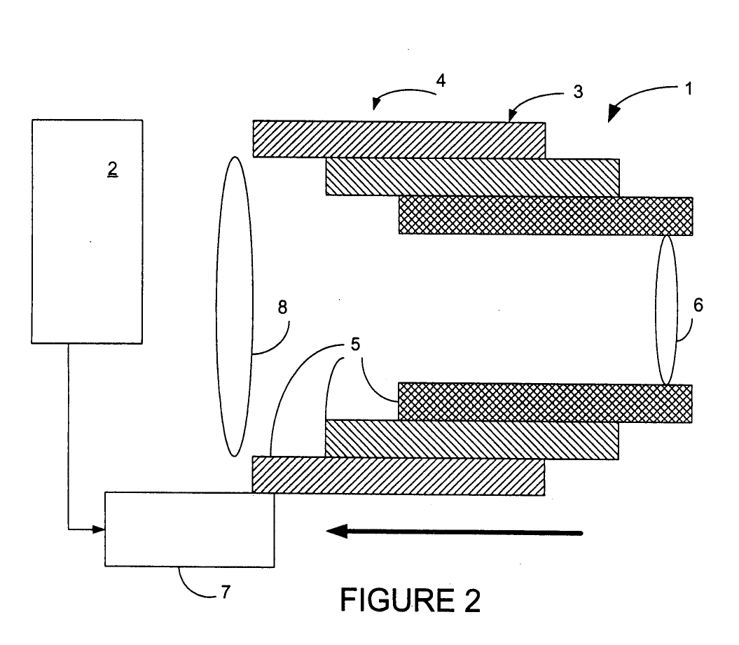

FIGS. 1 and 2 show a digital camera 1 having an internal miniature hard drive 2, shown in dashed lines in FIG. 1, a zoom lens assembly 3, having an extension tube 4, a forward lens 6 and one or more rearward lenses 8. The digital camera 1 also has an extender/retractor mechanism, which shall be called simply a retractor mechanism 7 for purposes of this application. For purposes of this patent application, the term “miniature hard drive” will refer to a hard drive having a disk diameter of 141 or less, although this is not to be taken as a limitation, and any very small hard disk drive that will fit in a digital camera casing can be used.

The extension tube 4 is made of several telescoping segments 5, which may take many configurations, as are known in the art. One such configuration has the segments joined together by spiraled grooves so that as the extension tube is extended, the segments twist and spiral outwards as the tube extends. Any such specific mechanism is not shown, as being outside of the scope of this discussion, but many such mechanisms will be known to those skilled in the art.

The retractor mechanism 7 is also shown in dashed lines in FIG. 1, as being hidden within the body of the camera 1. It too is known in several configurations which will be known to those skilled in the art. One such configuration involves a solenoid which extends a rod when electrically activated. The rod then serves to push the telescoping segments outward when the zoom assembly is to be extended, and pulls the telescoping rods inward when the zoom assembly is to be retracted. Again, any such specific retractor mechanism is not shown as being outside of the scope of this discussion, but many such mechanisms will be known to those skilled in the art. Any such mechanism which can activated by an electronic control signal may be used in the present invention.

The specifics of the hard drive's system for detecting an impending physical impact are disclosed in U.S. Pat. No. 6,101,062 to one of the current inventors. Generally, the motor spin current in the hard disk drive is used as a sensor to detect acceleration of the disk drive corresponding to a tipping or falling condition. In normal operation, the disk stack angular velocity (measured in revolutions per minute or RPM) is constantly monitored so that the disk drive control system can generate timing signals allowing the controller to accurately locate data addresses on the rotating disks. Disk stack RPM is accurately controlled at a constant value by a suitable feedback control loop which measures RPM and adjusts motor drive current to maintain the desired RPM. The rapidly rotating disk stack acts as a gyro system whose angular momentum resists any change in direction. In the event of a change in orientation of the disk drive such as that initiated by tipping or falling, gyroscopic forces are generated which act to increase friction of the bearings supporting the rotating disk stack resulting in a decrease in disk stack angular velocity. The change of disk stack RPM is detected by the normal feedback control loop electronics using the motor digital to analog converter (DAC) and an error signal can be generated to cause actuator park or unload action before impact of the falling disk drive occurs. This rapid detection and response to a falling condition avoids loss of data and damage to the disk drive magnetic recording heads and disks which might otherwise occur.

The various components of the disk drive system are controlled in operation by control signals generated by a control unit. Control signals include, for example, control signals and internal clock signals. Typically, the control unit comprises logic control circuits, storage means and a microprocessor. The control unit generates control signals to control various system operations such as drive motor control signals and head position and seek control signals. The control signals provide the desired current profiles to optimally move and position the slider to the desired data track on the disk. Read and write signals are communicated to and from the read/write heads by means of a recording channel.

The danger to the disk drive by dropping or impact may be addressed by providing an unload mechanism to lift the heads away from the disk surface so that the drive can tolerate accelerations which are far greater than are tolerable when the heads are “loaded” in the normal operating position. The time required to unload the actuator of a hard disk drive is less than 30 milliseconds. The time required to fall a distance of one foot is 250 milliseconds. The hard drive can be protected, as described below, by rapidly sensing potentially damaging motion such as falling and unloading the actuator in that event.

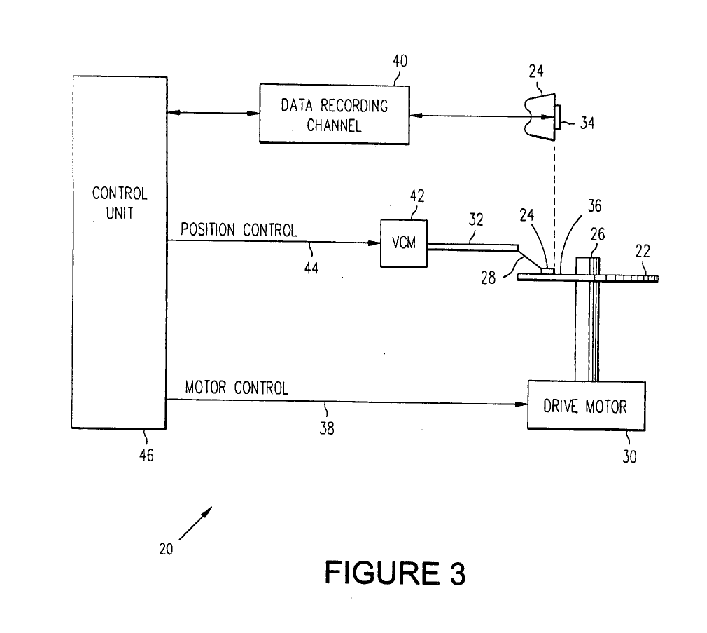

Referring now to FIG. 3, there is shown simplified view of a typical disk drive 20 as used in portable computers and in miniature hard drives which may be included in a digital camera. The same general features are included in the miniature hard drive, but it is not to be taken as a limitation that the features must be exactly duplicated for use in a digital camera.

As shown in FIG. 3, at least one rotatable magnetic disk 22 is supported on a spindle 26 and rotated by a disk drive motor 30. The magnetic recording media on each disk is in the form of an annular pattern of concentric data tracks (not shown) on disk 22. At least one slider 24 is positioned on the disk 22, each slider 24 supporting one or more magnetic read/write heads 34. As the disks rotate, slider 24 is moved radially in and out over disk surface 36 so that heads 34 may access different portions of the disk where desired data is recorded. Each slider 24 is attached to an actuator arm 32 by means of a suspension 28. The suspension 28 provides a slight spring force which biases slider 24 against the disk surface 36. Each actuator arm 32 is attached to an actuator means 42. The actuator means as shown in FIG. 3 may be a voice coil motor (VCM). The VCM comprises a coil movable within a fixed magnetic field, the direction and speed of the coil movements being controlled by the motor current signals supplied by controller 46.

During operation of the disk drive storage system, the rotation of disk 22 generates an air bearing between slider 24 and disk surface 36 which exerts an upward force or lift on the slider. The air bearing thus counter-balances the slight spring force of suspension 28 and supports slider 24 off and slightly above the disk surface by a small, substantially constant spacing during normal operation.

The various components of the disk storage system are controlled in operation by control signals generated by control unit 46, such as access control signals and internal clock signals. Typically, control unit 46 comprises logic control circuits, storage means and a microprocessor. The control unit 46 generates control signals to control various system operations such as drive motor control signals on line 38 and head position and seek control signals on line 44. The control signals on line 44 provide the desired current profiles to optimally move and position slider 24 to the desired data track on disk 22. Read and write signals are communicated to and from read/write heads 34 by means of recording channel 40.

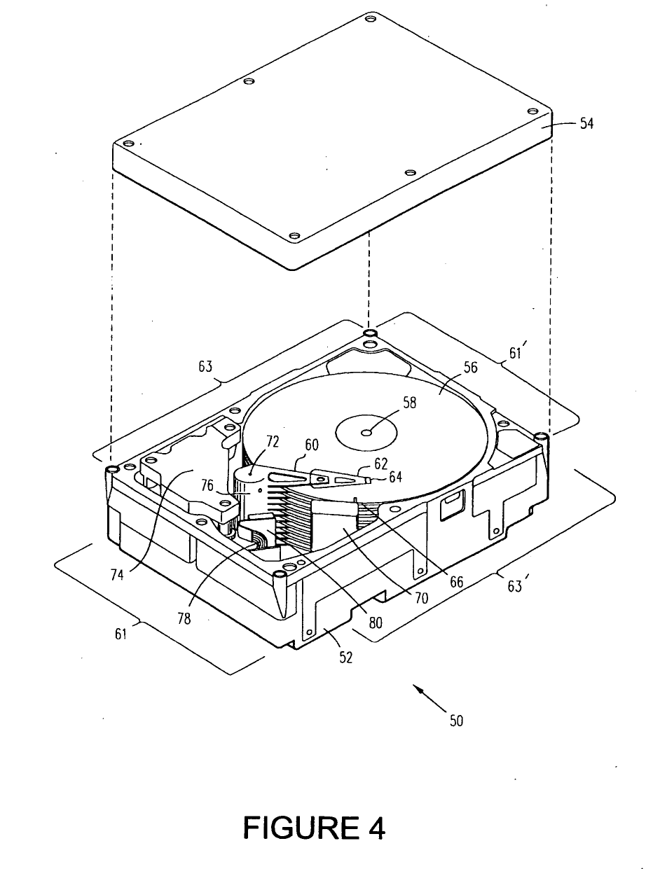

FIG. 4 shows a hard disk drive designated by the general number 50. The lid 54 of the disk drive is shown exploded. In operation, the lid would be disposed on top of the housing 52.

The disk drive 50 comprises one or more magnetic disks 56. The disks may be conventional particulate or thin film recording disks, which are capable of storing digital data in concentric tracks. In a preferred embodiment, both sides of the disks 56 are available for storage, and it will be recognized by one of ordinary skill in the art that the disk drive 50 may include any number of such disks 56.

The disks 56 are mounted to a spindle 58. The spindle 58 is attached to a spindle motor (not shown) which rotates the spindle 58 and the disks 56 to provide read/write access to the various portions of the concentric tracks on the disks 56.

An actuator assembly 76 includes a positioner arm 60, and a suspension assembly 62. The suspension assembly 62 includes a slider/transducer assembly 64 at its distal end. Although only one slider/transducer assembly 64 of the suspension assembly 62 is shown, it will be recognized that the disk drive 50 has one slider/transducer assembly 64 for each side of each disk 56 included in the disk drive 50. The positioner arm 60 further comprises a pivot 72 around which the positioner arm 60 pivots.

The disk drive 50 further includes a read/write chip 80. As is well known in the art, the read/write chip 80 cooperates with the slider transducer assembly 64 to read data from or write data to the disks 56. A flexible printed circuit member or actuator flex cable 78 carries digital signals between the read/write chip 80 and a connector pin assembly (not shown) which interfaces with the external signal processing electronics. The connector or shorter side of the drive is indicated by reference numerals 61, 61′, while the longer or drive side is indicated by the reference numerals 63, 63′.

The main function of the actuator assembly 76 is to move the positioner arm 60 around the pivot 72. Part of the actuator assembly 76 is the voice coil motor (VCM) assembly 74 which comprises a VCM bottom plate, a magnet or magnets and a VCM top plate in combination with an actuator coil. Current passing through the actuator coil interacts with the magnetic field of the magnet to rotate the positioner arm 60 and suspension assembly 62 around the pivot 72, thus positioning the slider/transducer assembly 64 as desired.

In a preferred embodiment, the hard disk drive 50 is equipped with a load/unload assembly 70 which supports load/unload ramps 66 at the outside diameter (OD) of each the disks 56. The load/unload ramps 66 are positioned to lift the suspension assemblies 62 axially with respect to the disks 56 so as to unload the slider/transducer assemblies 64 from the disks 56 when the actuator assembly 76 is fully rotated to the OD of the disks 56. When the slider/transducer assemblies 64 are in the unloaded position, the slider/transducer assemblies 64 are physically separated from the surfaces of the disks 56 and are thus protected from being damaged or causing disk damage due to shock from impact such as caused by the computer being dropped.

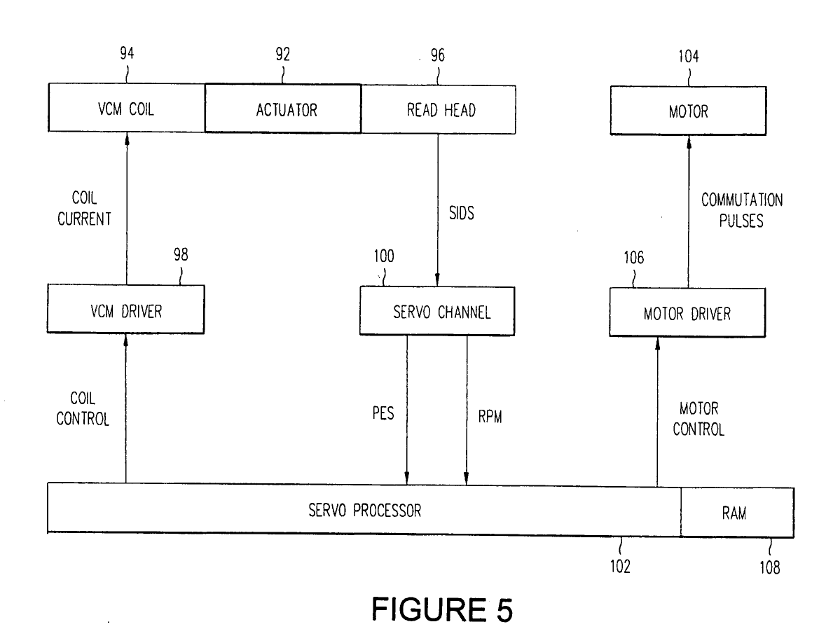

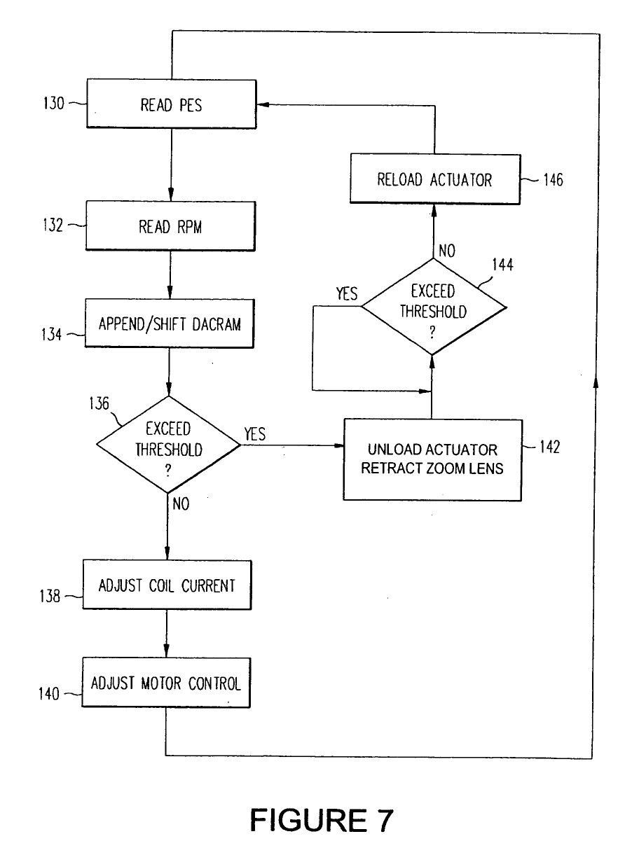

FIG. 5 is a block diagram illustrating a typical hard disk drive servo system used in many hard disk drives. Actuator 92 is a rotatable structure supporting the suspension assembly on which the read heads 96 are mounted and the VCM coil 94 which is part of the voice coil motor which radially positions the actuator 92 relative to the disk surfaces. In the operating disk drive, a read head 96 positioned over the desired data track on a disk reads sector identifiers (SIDS) written on sectors of the disk reserved for servo control information. The data corresponding to the SIDS is carried on signal lines to the servo channel 100 where the SID information stays in digital form where it is used by the servo processor to determine the correction to the motor spin current in order to maintain the constant operating RPM. When there is no SID signal from the heads (for example if the heads are unloaded or retracted) the motor can still maintain speed using the direct control based on back-EMF from the motor driver. This is of importance in being able to establish an “all clear” condition after the system reacts to a shock event by unloading or retracting. The system uses this to determine when it is safe to reload the heads when the motion has ceased as will be discussed in connection with FIG. 7. The RPM and PES signals generated in the servo channel 100 are sent to the servo processor 102 which processes the information and makes adjustments to the motor control and coil control output signals, respectively, in order to center the read head on track and maintain constant timing. The motor control output is sent to the motor driver 106 where it is converted to motor commutation pulses which are sent to the motor 104 that rotates the disk stack to adjust the disk RPM. The coil control output is sent to the VCM driver 98 where it is converted to coil control current which is sent to the VCM coil 94 to adjust the head radial position over the data track.

The servo processor 102 further comprises a servo processor random access memory (RAM) unit 108 which is used to store information used by the servo processor 102 to control file operations.

With continued reference to FIG. 5, the RPM and PES input signals to the servo processor 102 are analyzed and corrections are computed for each iteration represented by an update of one SID. With about 100-400 SIDs per disk revolution and a disk RPM in the range from 3600 to 15000 RPM in today's hard disk drives, the servo loop is updated every 0.01-0.2 milliseconds.

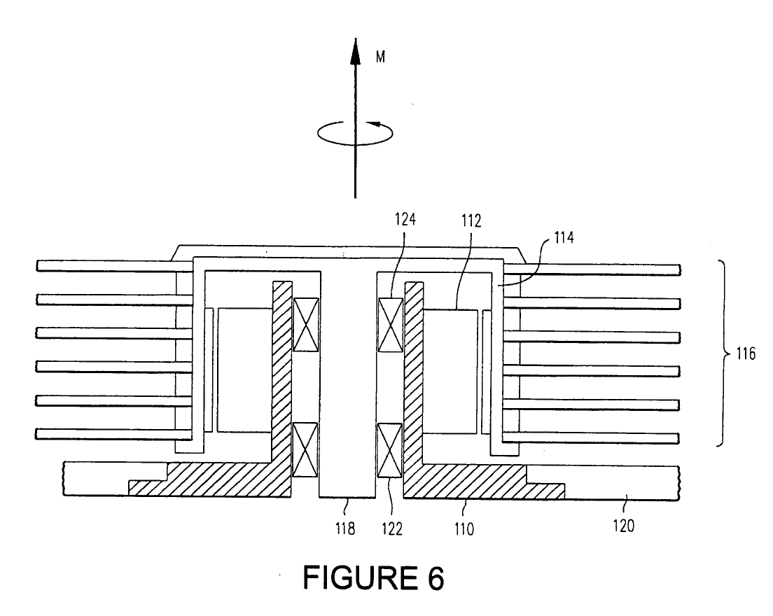

In a preferred embodiment of the present invention, the disk RPM variations as measured by the servo processor 102 RPM input signal are used to detect accelerations of the hard disk drive incorporated in a PC corresponding to potentially damaging motions such as falling. Referring now to FIG. 6, there is shown a simplified cross-sectional view of a typical spindle motor assembly 110 comprising a spindle motor 112 which rotates a spindle motor hub 114 supporting a disk stack 116. The spindle motor hub 114 is fixed to and axially symmetric with a spindle shaft 118 supported by a first bearing 122 and a second bearing 124 so that the spindle shaft 118 is free to rotate about the symmetry axis. The spindle motor assembly 110 is fixed to the disk drive housing 120.

The rapidly rotating disk stack 116 mounted on the spindle motor hub 114 comprises a mechanical gyro system as is known in the field of mechanical engineering. The disk stack 116 is supported by bearings 122, 124 which fix the disk stack position with respect to the drive housing 120 while allowing the disk stack 116 to rotate with minimal friction. The rotating disk stack 116 has an angular momentum M due to its mass and angular velocity. In FIG. 6, the angular momentum M is represented by an arrow directed upward in the plane of the paper for the rotation direction indicated on the Figure (counterclockwise as viewed from the top). When a torque is applied to the rotating disk stack 116 that forces the angular momentum vector M of the disk stack to change direction, gyroscopic forces are generated at the bearings 122, 124 that resist gyroscopic motion of the disk stack 116. These gyroscopic forces are perpendicular to the axis of the disk stack 116 and result in additional frictional forces on the bearings 122, 124. The additional bearing friction caused by the gyroscopic forces acts to slow the rotation of the disk stack 116 and is detectable by a change in RPM as measured by the servo channel in the server processor system.

FIG. 7, with continued reference to the previous figures, shows the flow diagram of the preferred logic of a protective reflex system which is triggered by a change in RPM as measured by the servo channel in the server processor system. The process starts by inputting to the servo processor 102 the PES signal, represented by function block 130, and the RPM signal, as represented by function block 132. The motor RPM is determined by the motor DAC which is input to the controller chip and hence determines the motor RPM. The servo processor 102 takes each iteration of the digitized RPM signal, appends it to a digital vector in the random access memory RAM 108 and shifts it. This process, represented by function block 134, generates a waveform in time representing the RPM at successive SIDs. One or more exponential averages, one with a short decay time constant and the other with a long decay time constant are computed from the motor DAC signal and compared. The case when the raw motor DAC signal is used is considered an exponential average with a decay constant of one. When the short decay exponential average is more than a threshold amount from the long decay exponential average, this suggests a potentially damaging motion is occurring so a high priority interrupt is triggered to retract the actuator and unload the suspension/slider assembly, as well as activating the retractor mechanism 7 to retract the zoom lens assembly 3. These actions are represented by function block 142.

The time constants that determine the short decay and long-decay, in addition to the threshold, are designed specifically to the application. For example, for a 600 Hz sample rate, a short decay constant of 0.1 and a long decay constant of 0.01 work well together. For applications having different sample rates, these time constants may be changed to achieve the desired response to a potentially damaging motion.

The exponential average is a cumulative average of a signal based on the following formula:
ExpAvg(I)=K*S(I)+(1−K)*ExpAvg(I-1)
where I=sample index, K=decay constant (0 to 1), and S=signal vector. The exponential average corresponding to the current sample is decay constant K multiplied by the current sample added to (1−K) multiplied by the prior exponential average. The size of K determines the decay rate, a larger K causes the ExpAvg to decay faster because it weighs the current sample more highly. Decay constant K represents a mathematical weighting factor in the exponential average, ExpAvg(I), chosen to determine the relative weight of 5 the current (most recent) sample S(I) to the previous iteration of the exponential average, ExpAvg(I-1). Therefore a high value of K is chosen for a time constant where rapid response to sudden changes in the signal is desired. A low value of K is chosen for a time constant to provide a reference ExpAvg of slow variations of the signal to which a rapid response is not desired.

At this point in the flow diagram, the main reflexive action, i.e., unloading of the sliders and the retraction of the zoom lens, has been accomplished. Further action can optionally be taken to enhance the protective system according to the invention. Following the unload action, the system continues to check the motor DAC exponential average delta, represented by function block 144, so that reload of the sliders, represented by function block 146, only takes place once the system is deemed stationary for a period of time. Alternatively, a power down procedure (not shown) may be called shutting down the entire hard disk drive.

Returning to the decision block 136, if the thresholds have not been exceeded, the signal processor 102 adjusts the coil current and motor control, represented by function blocks 138 and 140 respectively. This action represents the normal control function of the servo processor 102 in maintaining read head on-track position and constant disk stack RPM.

As it is used herein, motor DAC represents the amount of motor spin current on the output side of the servo system, not the input side. This, however, is not an important distinction in terms of the way the system works, because the servo system is designed to hold the motor speed constant, so the output equals input due to the effort of the servo system. Stated differently, if there is a disturbance or fluctuation that causes motor speed to change, the input side will detect the change, and a commensurate correction is applied to the output side. Thus, either the input side signal or the output side signal may be used in order to determine a motion event in the drive.

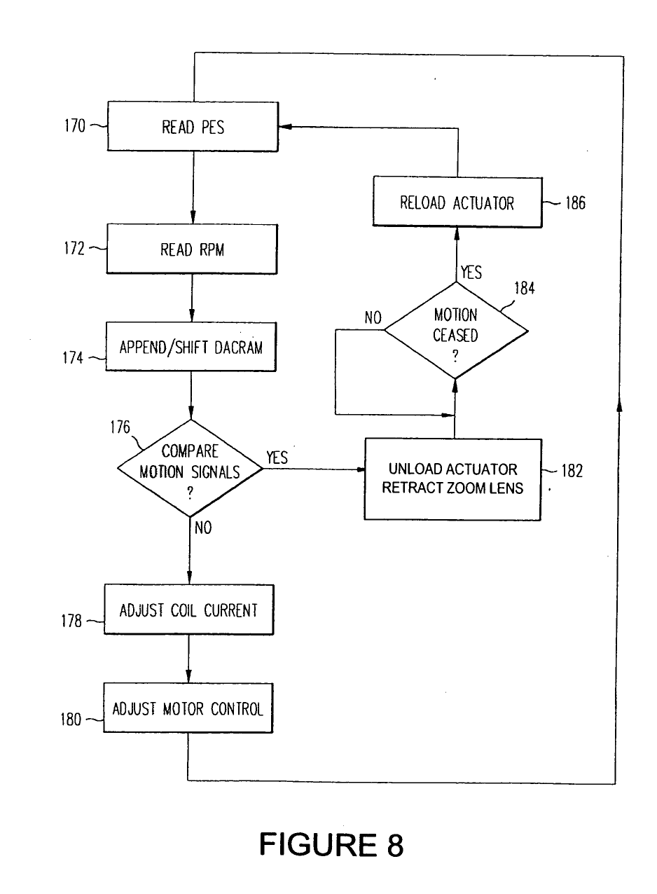

FIG. 8 shows the flow diagram of an alternative embodiment of the logic of a protective reflex system which also triggers from a change in RPM as measured by the servo channel in the server processor system but uses motion signatures for comparison rather than established threshold points. The process starts by inputting to the servo processor 102 the PES signal, represented by function block 170, and the RPM signal, as represented by function block 172. The servo processor 102 takes each iteration of the digitized RPM signal, appends it to a digital vector in the random access memory RAM 108 and shifts it. This process, represented by function block 174, generates a waveform in time representing the RPM at successive SIDs. This waveform may be filtered using standard methods well known in the art. This waveform in time is compared against a library of motion signatures stored in RAM 108 in decision block 176. The library of motion signatures in RAM 108 is derived during the hard disk drive development by subjecting the hard disk drive to known impulses in various combinations of direction and acceleration. When the waveform in time matches one of the motion signatures suggesting a potentially damaging motion is occurring, a high priority interrupt is triggered to retract the actuator and unload the suspension/slider assembly, as well as activating the retractor mechanism 7 to retract the zoom lens assembly 3. These actions are represented by function block 182.

At this point in the flow diagram, the main reflexive action, i.e., unloading of the sliders, has been accomplished. Further action can optionally be taken to enhance the protective system according to the invention. Following the unload action, a power down procedure (not shown) may be called shutting down the entire hard disk drive, or a continuing check loop to determine if the motion has ceased shown in decision block 184 may be used.

Returning to the decision block 176, if the waveform in time does not match the motion signatures in the RAM 108, the signal processor 102 adjusts the coil current and motor control, represented by function blocks 178 and 180 respectively. This action represents the normal control function of the servo processor 102 in maintaining read head on-track position and constant disk stack RPM.

The library of motion signatures described in FIG. 8 may take many forms and their specifics are discussed in greater detail in U.S. Pat. No. 6,101,062 to one of the current inventors. These motion signatures may be stored in the servo processor RAM as a library of potentially hazardous motions. Examination of the waveforms clearly show that a 10 millisecond window is sufficient to determine whether potentially hazardous motion is occurring. Thus a total response time of the system to detect and take protective action in the event of a fall or other damaging event is significantly less than the 250 milliseconds it takes to fall one foot.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention. METHOD AND APPARATUS FOR PROTECTING MECHANICAL LENS OF CAMERAS USING MINIATURE HARD DRIVE AS GYRO SENSOR

INVENTOR: SUK, Mike Atty. ref.: HSJ9-2005-0004US1 (60717-346801) THIS CORRESPONDENCE CHART IS FOR EASE OF UNDERSTANDING AND INFORMATIONAL PURPOSES ONLY, AND DOES NOT FORM A PART OF THE FORMAL PATENT APPLICATION.

| | |
|---|---|
| 1 | digital camera |
| 2 | miniature hard drive |
| 3 | zoom lens |
| 4 | extension tube |
| 5 | telescoping segments |
| 6 | forward lens |
| 7 | retractor mechanism |
| 8 | rearward lens |
| 20 | disk drive |
| 22 | disk |
| 24 | slider |
| 26 | spindle |
| 28 | suspension |
| 30 | motor |
| 32 | actuator arm |
| 34 | heads |
| 36 | disk surface |
| 38 | line |
| 40 | recording channel |
| 42 | actuator means |
| 44 | line |
| 46 | control unit |
| 50 | disk drive |
| 52 | housing |
| 54 | lid |
| 56 | disks |
| 58 | spindle |
| 60 | arm |
| 61 | connectors |
| 62 | suspension assembly |
| 64 | slider/transducer assembly |
| 66 | load/unload ramps |
| 70 | load/unload assembly |
| 72 | pivot |
| 74 | VCM assembly |
| 76 | actuator assembly |
| 78 | flex cable |
| 80 | read/write chip |
| 92 | actuator |
| 94 | VCM coil |
| 96 | read heads |
| 100 | servo channel |
| 102 | servo processor |
| 104 | motor |
| 106 | motor driver |
| 108 | RAM |
| 110 | motor assembly |
| 112 | spindle motor |
| 114 | motor hub |
| 116 | disk stack |
| 118 | spindle shaft |
| 122 | first bearing |
| 124 | second bearing |

What is claimed is:

1. A digital camera having protection from impact by falling comprising:
a miniature hard drive having an actuator assembly;
a zoom lens;
means for reading a motor current signal;
means for generating a first and second exponential average of a motor current signal, said first and second exponential average having different decay time constants;
comparator for comparing the difference between the first and second exponential averages with a threshold value stored in memory; and
interrupt signal generator for producing an interrupt signal if the exponential average difference exceeds the threshold value; and
zoom lens retractor mechanism for retracting said zoom lens in response to an interrupt signal from said interrupt signal generator.

2. The digital camera of claim 1, further comprising:
means for retracting the actuator assembly to move the magnetic recording head to a data free zone over the surface of the disk in response to said interrupt signal.

3. The digital camera of claim 1, further comprising:
means for unloading the magnetic recording head/suspension assembly from the surface of the disk in response to said interrupt signal.

4. The digital camera of claim 1, further comprising:
memory means for storing at least one said threshold value in memory.

5. A digital camera having protection from impact by falling comprising:
a miniature hard drive having an actuator assembly;
a zoom lens;
a device for reading a disk rotational velocity signal;
a device for generating a first and second exponential average of the disk rotational velocity signal, said first and second exponential averages having different decay time constants;
comparator for comparing the difference between the first and second exponential averages with a threshold value stored in memory; and
interrupt signal generator for producing an interrupt signal if the exponential average difference exceeds the threshold value; and
zoom lens retractor mechanism for retracting said zoom lens in response to an interrupt signal from said interrupt signal generator.

6. The digital camera of claim 5, further comprising:
a device for retracting the actuator assembly to move the magnetic recording head to a data free zone over the surface of the disk in response to said interrupt signal.

7. The digital camera of claim 5, further comprising:
a device for unloading the magnetic recording head/suspension assembly from the surface of the disk in response to the interrupt signal.

8. The digital camera of claim 5, further comprising:
memory device for storing at least one said threshold value in memory.

9. A method of preventing damage to a zoom lens system and miniature hard drive in a digital camera having a zoom lens, and a zoom lens retractor mechanism comprising:
A) providing a miniature hard drive internal to said digital camera capable of detecting that said digital camera is falling;
B) detecting that the condition exists that said digital camera is falling;
C) generating an interrupt signal when said condition is detected;
D) sending said interrupt signal to said zoom lens retractor mechanism; and
E) retracting said zoom lens in response to said interrupt signal.

10. The method of preventing damage of claim 9, wherein B comprises:
i) reading a motor current signal;
ii) generating a first and second exponential average of the motor current signal, said first and second exponential averages having different decay time constants; and
iii) comparing the difference between the first and second exponential averages with a threshold value.

11. The method of preventing damage of claim 10, wherein C comprises:
i) generating an interrupt signal if the exponential average difference exceeds the threshold value.

12. The method of preventing damage of claim 10, wherein:
one of said first or second exponential averages is comprised of a motor DAC signal with a time decay constant of one.

13. The method of preventing damage of claim 9, wherein E further comprises:
i) retracting an actuator arm to move the heads to a data free zone of a disk in response to said interrupt signal.

14. The method of preventing damage of claim 9, wherein E further comprises:
i) unloading a suspension assembly from over a surface of a disk in response to said interrupt signal.

15. The method of preventing damage of claim 10, wherein:
said motor current signal comprises a motor DAC signal.

16. The method of preventing damage of claim 9, wherein B comprises:
i) reading a disk rotational velocity signal;
ii) generating a first and second exponential average of the disk rotational velocity signal, said first and second exponential averages having different decay time constants; and
iii) comparing the difference between the first and second exponential averages with a threshold value.

17. The method of preventing damage of claim 9, wherein C comprises:
i) generating an interrupt signal if the exponential average difference exceeds the threshold value.

18. The method of preventing damage of claim 9, wherein E further comprises:
i) retracting an actuator arm to move the heads to a data free zone of a disk in response to said interrupt signal.

19. The method of preventing damage of claim 9, wherein E further comprises:
i) unloading a suspension assembly from over a surface of a disk in response to said interrupt signal.
